(19) United States
(12) Patent Application Publication
(10) Pub. No.: US 2025/0104328 A1
(43) Pub. Date: Mar. 27, 2025

(54) RAYTRACING STRUCTURE TRAVERSAL BASED ON WORK ITEMS

(71) Applicants: ADVANCED MICRO DEVICES, INC., Santa Clara, CA (US); ATI TECHNOLOGIES ULC, MARKHAM (CA)

(72) Inventors: David William John Pankratz, Toronto (CA); Michael John Livesley, Milton Keynes (GB)

(21) Appl. No.: 18/372,991

(22) Filed: Sep. 26, 2023

(51) Int. Cl. G06T 15/06; G06T 15/80; G06T 17/00

(52) U.S. Cl. CPC G06T 15/06; G06T 15/80; G06T 17/005

(57) ABSTRACT

A processor employs work items to manage traversal of an acceleration structure, such as a ray tracing structure, at a hardware traversal engine of a processing unit. The work items are structures having a relatively small memory footprint, where each work item is associated both with a ray and with a corresponding portion of the acceleration structure. The hardware traversal engine employs a work items to manage the traversal of the corresponding portion of the acceleration structure for the corresponding ray.

### BACKGROUND

To improve the fidelity and quality of generated images, some software, and associated hardware, implement ray tracing operations, wherein the images are generated by tracing the path of light rays associated with the image. Some of these ray tracing operations employ a tree structure, such as a bounding volume hierarchy (BVH) tree, to represent a set of geometric objects within a scene to be rendered. The geometric objects (e.g., triangles or other primitives) are enclosed in bounding boxes or other bounding volumes that form leaf nodes of the tree structure, and then these nodes are grouped into sets, with each set enclosed in its own bounding volume that is represented by a parent node on the tree structure, and these sets then are bound into larger sets that are similarly enclosed in their own bounding volumes that represent a higher parent node on the tree structure, and so forth, until there is a single bounding volume representing the top node of the tree structure and which encompasses all lower-level bounding volumes.

To perform some ray tracing operations, the tree structure is used to identify potential intersections between generated rays and the geometric objects in the scene by traversing the nodes of the tree, where at each node being traversed a ray of interest is compared with the bounding volume of that node to determine if there is an intersection, and if so, continuing on to a next node in the tree, where the next node is identified based on the traversal algorithm, and so forth. However, conventional approaches to traversing the tree structure sometimes consume a relatively high amount of system resources, or require a relatively large amount of time, thus limiting the overall quality of the resulting images.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing unit that employs work items to manage ray tracing at a hardware traversal engine in accordance with some embodiments.

FIG. 2 is a block diagram illustrating an example of the traversal engine of FIG. 1 generating and associating different work items with different sections of a tree structure in accordance with some embodiments.

FIG. 3 is a block diagram illustrating an example of a work item store and ray data store for the processing unit of FIG. 1 in accordance with some embodiments.

FIG. 4 is a block diagram illustrating an example of a work item employed by the traversal engine of FIG. 1 in accordance with some embodiments.

FIG. 5 is a flow diagram of an example of employing work items to traverse a raytracing tree structure in accordance with some embodiments.

FIG. 6 is a block diagram of a processing system including the processing unit of FIG. 1 in accordance with some embodiments.

### DETAILED DESCRIPTION

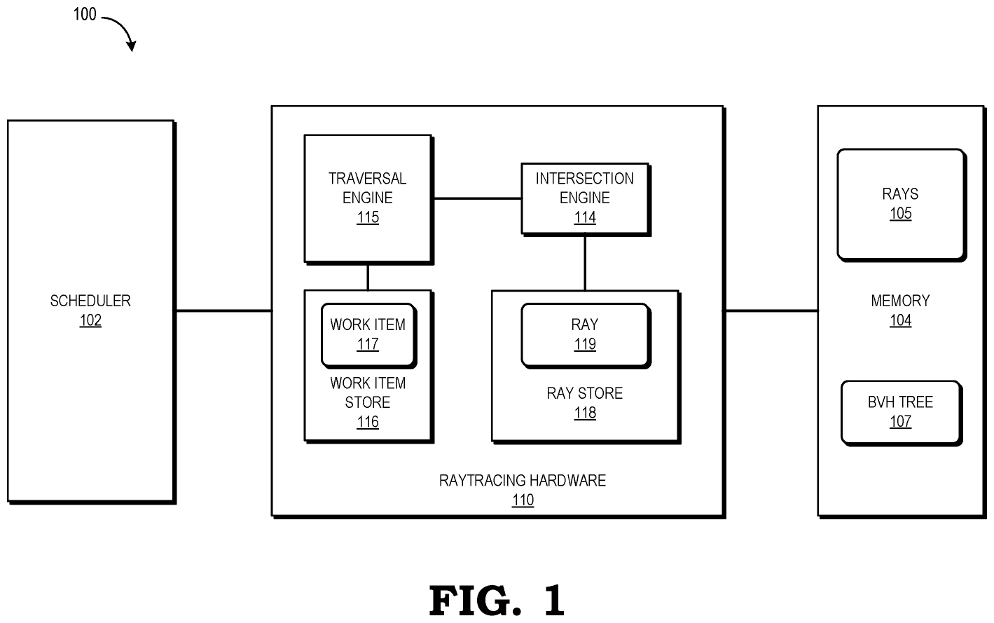

FIGS. 1-6 illustrate techniques for employing work items to manage traversal of an acceleration structure, such as a ray tracing structure, at a hardware traversal engine of a processing unit. The work items are structures having a relatively small memory footprint, where each work item is associated both with a ray and with a corresponding portion of the acceleration structure. The hardware traversal engine employs a work items to manage the traversal of the corresponding portion of the acceleration structure for the corresponding ray. Rays have a much larger storage overhead than work items, and thus employing work items, rather than rays, for traversal operations improves ray tracing performance (by allowing processing of more work items overall) with relatively low circuit area. For example, by employing relatively small-footprint work items to manage traversal of the acceleration structure, the processing unit is able to make efficient use of the traversal engine and other ray tracing hardware, such as by increasing the number of ray tracing operations that are executed in parallel by the ray tracing hardware.

To illustrate via an example, in some embodiments the processing unit includes both a traversal engine (TE) to perform acceleration structure traversal operations and an intersection engine (IE) to perform node intersection operations for the TE. One or both of the TE and IE are configured to perform up to N operations in parallel, where N is an integer. Further, the processing unit includes a local memory, referred to as a ray store, that stores ray data for the rays being processed by the TE and IE. To conserve circuit area at the processing unit, the ray store is sized such that it is only able to store a subset of the rays to be processed by the ray tracing hardware. The ray data for the entire set of rays is thus stored at a larger memory structure, such as system memory for the processing unit. Accordingly, if the TE or IE is to execute a ray tracing operation for ray data that is not stored at the ray store, the processing unit retrieves the ray data from system memory and stores the retrieved data at the ray store, where the ray data is accessed by the TE and the IE.

However, in many cases memory latency impacts the efficiency of the TE traversing an acceleration structure. To traverse the accelerations structure for a ray, the TE searches for the acceleration structure for an intersection, which requires several operations, including reading a node of the acceleration structure, determining an intersection with the node, determining a next node of the acceleration structure based on the intersection and then fetching the next node. At least some of these operations, such as the fetching of the different nodes, results in at least some memory latency, wherein the TE cannot make progress on the traversal for that ray until memory returns the required data. The amount of memory latency for an operation depends on where the required data is stored in a memory hierarchy of the processing unit. The overall impact of this memory latency is reduced by increasing the number of rays that are “in flight” at the raytracing hardware—that is, by increasing the number of raytracing operations being managed by the raytracing hardware, so that if traversal for a given ray cannot progress due to memory latency, it is more likely that the data is available to progress the traversal of the acceleration structure for a different ray. However, increasing the size of the ray store to increase the number of rays in flight results in a relatively large ray store that consumes a high amount of circuit area. Further, for at least some raytracing scenarios (such as scenarios involving reflections off of glossy surfaces or global illumination), there are not a large number of rays to process, increasing the overall impact of memory latency.

Using the techniques described herein, the ray tracing hardware employs work items to store data for performing at least some ray tracing operations, such as tree traversal operations. The work items store only the information required to perform the tree traversal operations for a corresponding ray, rather than all of the ray data. This allows a relatively high number of work items to be stored at the processing unit. For example, in some embodiments, the processing unit includes a work item store that stores up to M work items, and a ray store that stores up to N rays. This allows the processing unit to reduce the impact of memory latency and increase the number of ray tracing operations executed in parallel, without also requiring the processing unit to employ a relatively large ray store.

For purposes of description, FIGS. 1-5 are described with respect to examples wherein a traversal engine is implemented at a GPU and performs a traversal process to traverse a BVH tree. However, it will be appreciated that, in other embodiments, the techniques described herein are implemented at different types of processing units, are implemented to traverse a different type of acceleration structure, or any combination thereof. For example, in various embodiments, the techniques described herein are implemented at one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), application specific integrated circuits, or any combination thereof.

FIG. 1 illustrates a block diagram of a GPU 100 generally configured to perform ray tracing and other graphical operations on behalf of a processing system in accordance with some embodiments. The processing system is generally configured to execute sets of instructions (e.g., computer programs) to perform specified tasks on behalf of an electronic device. Accordingly, in different embodiments, the GPU 100 is incorporated into any one of a number of electronic devices, such as a desktop computer, laptop computer, server, smartphone, tablet, game console, and the like.

The GPU 100 is configured to receive commands (e.g., draw commands) from another processing unit (not shown) of the processing system, to generate one or more commands based on the received commands, and to execute the generated commands by performing one or more graphical operations. At least some of those generated commands require texture operations, including ray tracing operations. To facilitate execution of the texture operations, the GPU 100 includes a scheduler 102, a memory 104, and a raytracing hardware (RT) module 110.

The scheduler 102 is generally configured to schedule, or sequence, commands for execution at the various modules of the GPU 100, including the RT module 110. In at least some embodiments, the scheduler 102 is configured to receive the commands for scheduling from one or more of these same modules, or from another module of the GPU 100, such as from a command processor (not shown).

The memory 104 is a memory configured to store data used for operations at the GPU 100, including ray tracing and other texture operations. In different embodiments, the memory 104 is memory embedded within the GPU 100, is system memory external to the GPU 100, or any combination thereof. In the depicted embodiment, the memory 104 stores ray data 105, representing the data associated with the rays used for the raytracing operations described herein. For example, in some embodiments, the ray data 105 stores, for each ray for which ray tracing is to be performed, a ray identifier (referred to as a ray ID) (in at least some embodiments, the ray ID is not separately stored, but is indicated by the index for the entry or line where the ray data is stored), vector information indicating the origin of the ray in a coordinate frame and the direction of the ray in the coordinate frame, and any other data needed to perform ray tracing operations.

The memory 104 also stores a BVH tree 107 (referred to hereinafter as BVH 107) that is employed by the GPU 100 to implement ray tracing operations. The BVH 107 includes a plurality of nodes organized as a tree, with bounding boxes or other bounding volumes of objects of a scene to be rendered, wherein the bounding volumes form leaf nodes of the tree structure, and then these nodes are grouped into small sets, with each set enclosed in their own bounding volumes that represent a parent node on the tree structure, and these small sets then are bound into larger sets that are likewise enclosed in their own bounding volumes that represent a higher parent node on the tree structure, and so forth, until there is a single bounding volume representing the top node of the BVH 107 and which encompasses all lower-level bounding volumes.

The RT module 110 includes one or more circuits collectively configured to execute ray tracing and other texture operations. In particular, the RT module 110 is configured to perform intersection operations, to identify whether a given ray intersects with a given BVH node, and traversal operations, to traverse the BVH 107 based on the intersection operations. To facilitate these operations, the RT 110 includes an intersection engine 114 and a traversal engine (TE) 115. The operations of the intersection engine 114 and TE 115 are described further below. In various embodiments, the intersection engine 114 and TE 115 are hardware circuitry designed and configured to perform the corresponding operations described below. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)).

The intersection engine 114 is configured to receive ray data, identifying a particular ray to be used for ray tracing, and node data, indicating a node of the BVH 107. The intersection engine 114 executes a node intersection process to identify whether the ray intersects with the node (referred to as an intersection hit) or does not intersect with the node (referred to as an intersection miss). The intersection engine 114 provides the intersection miss and intersection hit data, along with ray data and BVH node data, to the TE 115. In at least some embodiments, the intersection engine 114 is configured to perform multiple intersection operations in parallel, including intersection operations for different rays. Thus, for example, in some embodiments the intersection engine 114 concurrently performs an intersection operation for Ray A (determining whether Ray A intersects with a node of the BVH 107) and an intersection operation for Ray B (determining whether Ray B intersects with the same or a different node of the BVH 107).

The TE 115 is a hardware engine including one or more circuits that are collectively configured to perform tree traversal operations. In particular the TE 115 is configured to receive the intersection information (hit data, miss data, ray data, and BVH node data) from the intersection engine 114. Based on the intersection information, the TE 115 executes a traversal process. For example, in some embodiments, the TE 115 implements a stack-based depth-first BVH traversal process, wherein one or more traversal stacks are used to store addresses of next nodes for a ray to intersect. Tree nodes are visited in depth-first order and, for every intersected interior node, the intersected child nodes are sorted based on their distance to ray origin. The furthest nodes are pushed onto stack, and the closest node is used as the next intersect for the next iteration of the traversal loop. In some embodiments, the traversal loop is implemented using a state machine, so that the TE 115 is able to process different rays per sequential clock cycles. In other embodiments, the TE implements a stackless traversal process, a while-while traversal process, and the like. In some embodiments, according to the traversal process, the TE 115 identifies one of three possible outcomes: 1) a next node of the BVH 107 to be tested for intersection with a ray; 2) a shader to be executed (e.g., an any-hit shader); or 3) an end of the tree traversal process for the current ray. For purposes of description, the traversal operations of the TE 115 and the intersection operations of the intersection engine 114 are collectively referred to as raytracing operations.

To support execution of the raytracing operations, the RT 110 includes a ray store 118 to store ray data (e.g., ray 119) and a work item store 116 to store work items (e.g., work item 117). The ray data stored at the ray store 118 is employed by the intersection engine when determining whether a ray intersects with a node of the BVH 107. In at least some embodiments, the ray store 118 stores a subset of the ray data 105 at the memory 104. In some embodiments, when the TE 115 requests intersection engine 114 to perform an intersection operation for a ray, the TE 115 determines whether the ray data for the ray is stored at the ray store 118. If not, the TE 115 requests the ray data from the memory 104 and stores the requested ray data at the ray store 118.

The TE 115 uses the work items stored at the work item store 116 to perform traversal operations for the BVH 107. Each work item is associated with a ray, and with at least a portion of the BVH 107 to be traversed for the ray. For example, in some embodiments, each work item includes a work item identifier, a ray identifier for the ray associated with the work item, a terminal node indicating the top-most node of the BVH 107 for the work item, a current node identifier indicating the current node associated with the work item for which an intersection operation is to be performed, and the current T value for the ray, which indicates the closest hit object that has been identified for the ray relative to the origin. In some embodiments, the T value is initialized to the ray Tₘₐₓ, which is the furthest distance the an application has identified for which intersections from the ray origin are to be identified. In at least some cases, a work item also includes data indicating whether the work item is linked to another work item, such as to another work item associated with the same ray but with a different portion of the BVH 107. Further, in some embodiments the work items do not include all of these fields. For example, in some embodiments the work items do not include a terminal node or current node identifier.

In some embodiments, the TE 115 uses a work item to store data for traversing a portion of the BVH 107 for a corresponding ray. For example, in some embodiments, in response to the intersection engine 114 indicating an intersection with a node of the BVH 107, the TE 115 determines whether the intersected node has multiple child nodes. If so, the TE 115 generates one or more additional work items, and assigns each work item to a different child node. The TE 115 then employs each work item to traverse the subsection of the BVH 107.

For example, in some embodiments the TE 115 is generally configured to manage and perform operations to progress traversal of the BVH 107. For example, if a new ray arrives from a shader, the TE 115 is configured to allocate a ray ID for the ray, the ray data is loaded into the ray store 118, and TE 115 requests an initial node of the BVH 107 from memory. When a requested BVH node is returned from memory, the TE 115 requests an intersection operation from the intersection engine 114. Based on the intersection results, the TE 115 performs one or more operations, such as pushing results onto a stack, requesting another BVH node from memory, stopping traversal of the BVH 107 for the corresponding ray, and the like. The TE 115 uses the work items to manage these different operations for the different corresponding sections of the BVH 107, and for the corresponding ray. Further, the TE 115 is configured to perform these different operations for multiple work items concurrently during each clock cycle of the TE 115.

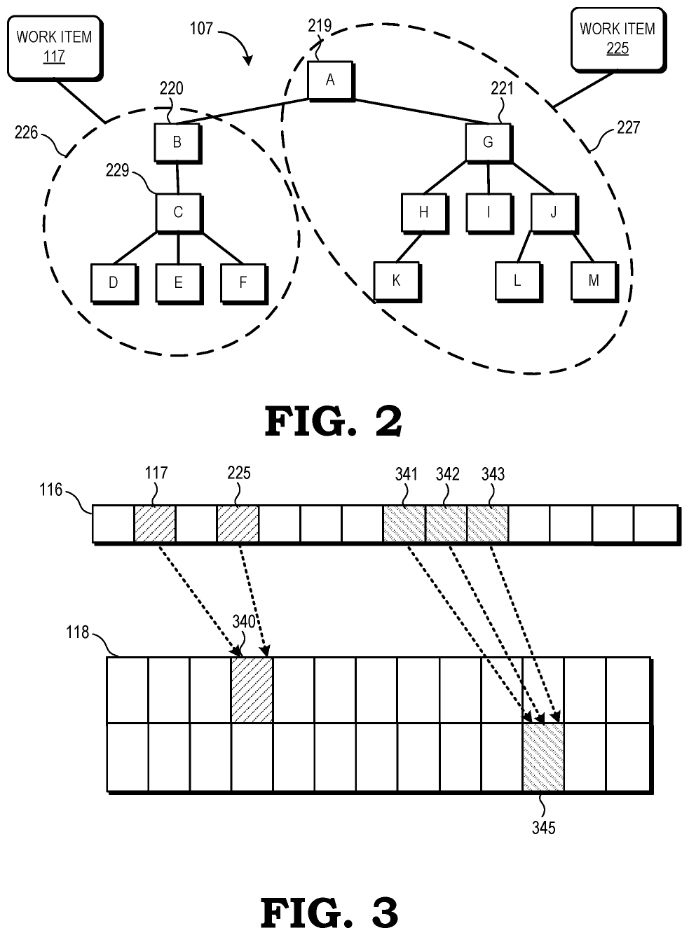

FIG. 2 illustrates a block diagram of an example of the TE 115 generating and employing different work items to traverse the BVH 107 in accordance with some embodiments. In the illustrated example, the BVH 107 includes a plurality of nodes, such as a node 219 and its child nodes 220 and 221. To traverse the BVH 107, the TE 115 generates a work item 225. The work item 225 is generated to include the ray ID for the ray and an identifier for the current node (node 219), along with other data used to traverse the BVH 107, as described further herein. The TE 115 then requests an intersection operation for the node 219 from the intersection engine 114. It is assumed that in response, the intersection engine 114 indicates an intersection with the node 219.

In response to the indication of the intersection, the TE 115 determines that node 219 has two child nodes, nodes 220 and 221, corresponding to two subsections of the BVH 107, designated sections 226 and 227, respectively. Accordingly, the TE 115 generates a new work item, designated work item 117. The work item 117 is generated to include the ray ID for the ray and an identifier for the closest child node (node 220), along with other data used to traverse the BVH 107.

The TE 115 then uses the different work items 117 and 225 to traverse the corresponding sections of the BVH 107 (sections 226 and 227, respectively). For example, in some embodiments, the TE 115 identifies, based on the work item 117, that the current node for section 226 is node 220. In response, the TE 115 requests an intersection operation for the node 220 from the intersection engine 114. It is assumed that in response, the intersection engine 114 indicates an intersection with the node 220. The TE 115 determines that the node 220 has one child node, designated node 229, and updates the current node at the work item 117 to indicate node 229. In similar fashion, the TE 115 continues to use the work item 117 to traverse section 226 of the BVH 107 until a final node of the section is reached.

For work item 225, the TE 115 identifies, that the current node for section 227 is node 221. In response, the TE 115 requests an intersection operation for the node 221 from the intersection engine 114. It is assumed that in response, the intersection engine 114 indicates an intersection with the node 221. The TE 115 determines that the node 221 has three child nodes. In some embodiments, the TE 115 generates new work items for two of the child nodes and uses the new work items to traverse the corresponding sections of the BVH 107, while continuing to use the work item 225 for the remaining section. Thus, in the example of FIG. 2, the TE 115 uses different work items to store traversal state information for different corresponding sections of the BVH 107, and uses the traversal state information for each section to traverse that section. In at least some embodiments, the TE 115 does not automatically create a work item for each child node when the parent node is intersected. For example, in some embodiments the TE 115 creates a work item only when the number of rays being processed is below a corresponding threshold, when the total number of work items being processed or stored is below a corresponding threshold, when the number of work items associated with the ray is below a corresponding threshold, and the like, or any combination thereof.

By using multiple work items to traverse different sections of the BVH 107 for a given ray, the GPU 100 is able to more efficiently execute raytracing operations over time while employing a relatively small ray store 118. This can be better understood with reference to FIG. 3, which illustrates a block diagram of the work item store 116 and the ray store 118. In the illustrated embodiment, the work item store 116 is sized to store up to N work items, where Nis an integer. The ray store 118 is sized to store up to M rays (that is, ray data corresponding to M different rays), where M is an integer. In at least some embodiments, N is greater than M, and multiple work items stored at the work item store 116 correspond to a single ray stored at the ray store 118. For example, work items 117 and 225 correspond to ray 340. That is work items 117 and 225 are used by the TE 115 to traverse the BVH 107 for the ray 340. Similarly, work items 341, 342, and 343 correspond to ray 345, so that work items 341, 342, and 343 are used by the TE 115 to traverse the BVH 107 for the ray 345. Further, an entry of the work item store 116 is smaller (and in many cases much smaller, such as ten to thirty times smaller) than an entry of the ray store 118 (that is, the amount of memory required to store a work item is smaller than the amount of memory required to store ray data for a ray). For example, in some embodiments each work item requires three data words, and each entry of the work item store 116 corresponds to three data words, while the ray data for a ray requires twenty-six data words, and each entry of the work item store 118 corresponds to twenty-six data words. In other embodiments each work item requires as little as one data word.

As noted above, by using work items, and the work item store 116, to traverse the BVH 107, the work item store 116 and ray store 108 are able to be sized to support efficient execution of ray tracing operations at the GPU 100. In particular, by employing work items, and the work item store 116, to traverse the BVH 107, the GPU 100 is able to make efficient use of the intersection engine 114 and TE 115, by increasing the number of rays, and BVH node reads, that are “in flight”—that is, that are either being processed at the RT module 110, or are awaiting retrieval of data before proceeding to the next stage of being processed at the RT module 110. This increases the likelihood that, for a given clock cycle, the TE 115 has useful work to do, and increases the amount of useful work is available for the TE 115 during each clock cycle.

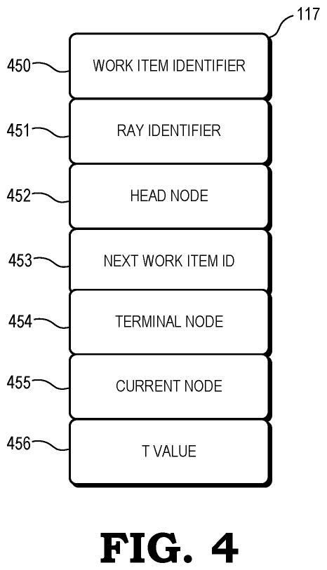

FIG. 4 illustrates a block diagram of the work item 117 in accordance with some embodiments. In the depicted embodiment, the work item 117 includes a plurality of fields, designated fields 450-457, wherein each field stores different traversal state information for a corresponding ray. To indicate a particular state, each of the fields 450-457 stores data representing the value of the corresponding field. To illustrate, field 450 is a work item identifier field, and the value stored at the field 450 is an identifier for the work item, such that the value differentiates the work item from other work items associated with the same ray. The field 451 is a ray identifier field, and thus the value stored at the field 451 is an identifier for the ray corresponding to the work item, such that the value differentiates the ray from other rays being processed at the RT 110.

The field 452 is a head node field, and thus the value stored at the field 452 indicates whether the work item is a head work item. Thus, in some embodiments, the head node field stores a Boolean value indicating “true” if the work item is associated with a head node, and “false” if the work item is not associated with a head node. The field 453 is a next work item identifier field, and thus the value stored at the field indicates a next work item associated with the same ray. The next work item identifier field 453 thus provides a link to another work item associated with the same ray. The head work item field 452 and next work item identifier field 453 together allow the work items for a given ray to be organized as a linked list. Thus, in some embodiments, the TE 115 performs BVH traversal operations for a given ray by, at least in part, traversing the linked list of work items, with the work item having a “true” head node field value being the final work item in the linked list. In some embodiments, the final work item would also not indicate any next work item.

The field 454 is a terminal node field, and the value stored at the terminal node field 454 is an identifier for the top-most node of the associated section of the BVH 107. The terminal node field 454 allows the overwriting of stack content to indicate when traversal is complete for the corresponding work item. For example, in some embodiments the TE 115 implements a stackless walkback, and when the TE 115 reaches the node indicated by the terminal node field 454, the TE 115 determines that traversal for the associated work item is complete. In some embodiments, the terminal node field 454 is not used or is omitted from the work item.

The field 455 is a current node field, and thus the value stored at the current node field 455 indicates the current node, for the corresponding work item, for which an intersection operation is to be performed at the intersection engine 114. Based on the results of the intersection operation, the TE 115 updates the current node field, thus traversing the section of the BVH 107 corresponding to the work item.

The field 456 is a T value field. The T value field stores the T value for a tested node of the BVH 107. In some cases, if the T value for a work item is closer than the current ray Tₘₐₓ the TE 115 stalls traversal for the ray until the corresponding work item is the head work item. If the T value is then still closer than the current ray Tₘₐₓ, the Tₘₐₓ value at the ray store 118 is updated with the T value stored at the work item. If the head work item set the value of Tₘₐₓ that is closer than the T value field 456, the TE 115 discards the T value field 456 for the current work item and carries on traversing the BVH 107. In some embodiments, the T value field 456 is not used or is omitted from the work item

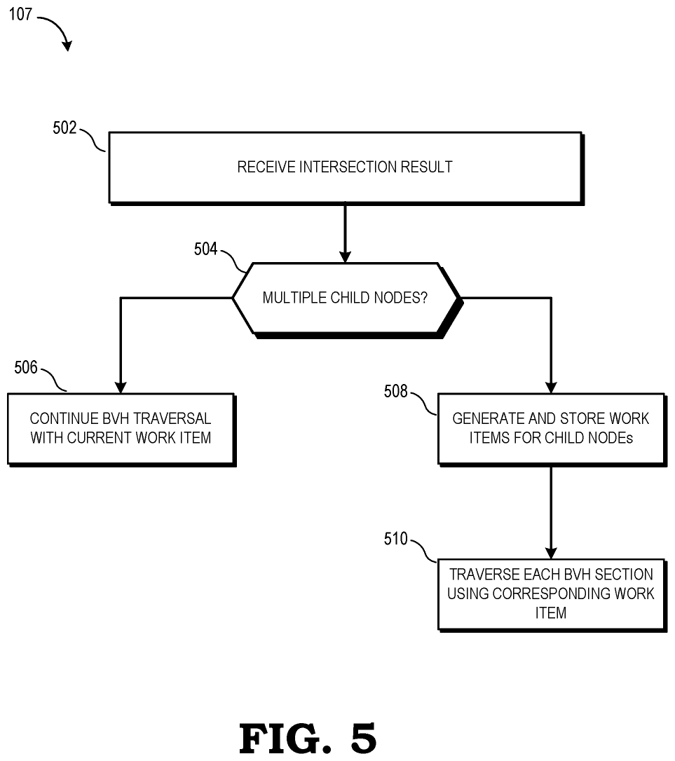

FIG. 5 illustrates a flow diagram of a method 500 of generating and storing work items for acceleration structure traversal in accordance with some embodiments. For purposes of description, the method 500 is described with respect to an example implementation at the GPU 100 of FIG. 1, but it will be appreciated that in other embodiments the method 500 is implemented at different processing units having different structures.

At block 502, the TE 115 receives an intersection result from the intersection engine 114, indicating that a ray corresponds with a current node of the BVH 107. It is assumed that the TE 115 has previously requested the intersection result based on traversing the BVH 107 with a current work item (e.g., an initial work item generated for an initial node of the BVH 107). In response to the intersection result, at block 504 the TE 115 accesses the BVH 107 and determines if the current node has multiple child nodes. If not, the method flow moves to block 506 and the TE 115 continues to traverse the BVH 107 with the current work item.

If at block 504, the TE 115 determines that the current node has multiple child nodes, the method proceeds to block 508 and the TE 115 generates work items for the child nodes. For example, in some embodiments, the TE 115 assigns the current work item to one of the child nodes, and then generates a different work items for each additional child node. The TE 115 stores each work item at the work item store 116. In at least some embodiments, the TE 115 does not automatically create a work item for each child node when the parent node is intersected. For example, in some embodiments the TE 115 creates a work item only when the number of rays being processed is below a corresponding threshold, when the total number of work items being processed or stored is below a corresponding threshold, when the number of work items associated with the ray is below a corresponding threshold, and the like, or any combination thereof. The method proceeds to block 510, and the TE 115 uses each work item to traverse the corresponding section of the BVH 107.

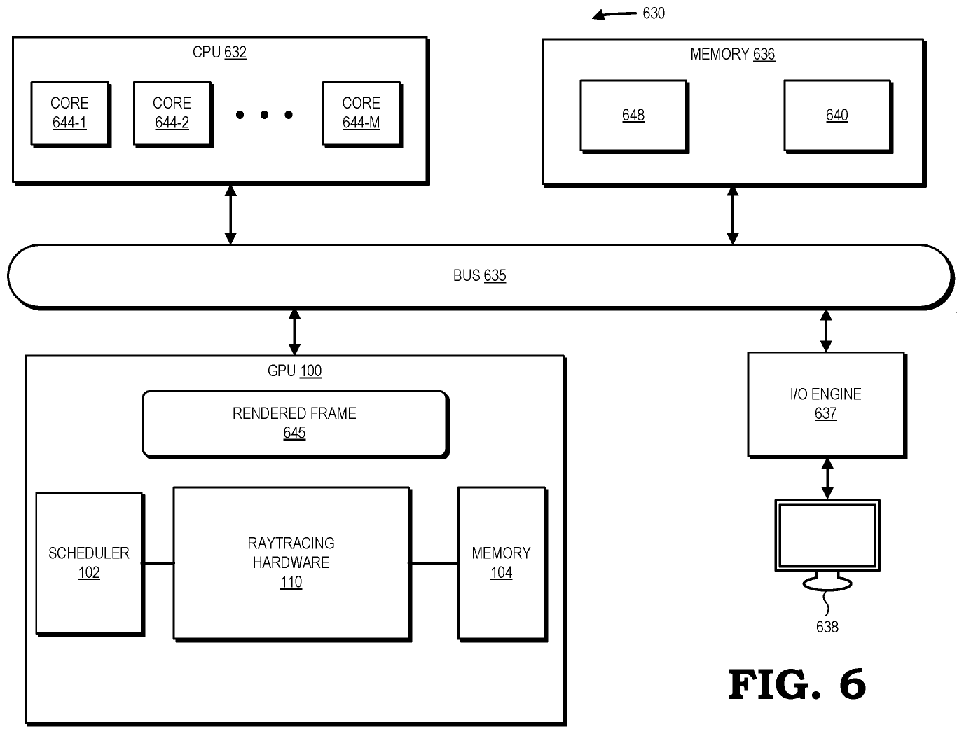

Referring now to FIG. 6, a processing system 630 configured to perform raytracing based on stored work items is presented, in accordance with some embodiments. Processing system 100 includes or has access to a memory 636 or other storage component implemented using a non-transitory computer-readable medium, for example, a dynamic random-access memory (DRAM). However, in implementations, the memory 636 is implemented using other types of memory including, for example, static random-access memory (SRAM), nonvolatile RAM, and the like. According to implementations, the memory 636 includes an external memory implemented external to the processing units implemented in the processing system 630. The processing system 630 also includes a bus 635 to support communication between entities implemented in the processing system 630, such as the memory 636. Some implementations of the processing system 630 include other buses, bridges, switches, routers, and the like, which are not shown in FIG. 1 in the interest of clarity.

The processing system 630 includes the GPU 100 to implement one or more of the techniques described herein The GPU 100 is configured to render a set of rendered frames each representing respective scenes within a screen space (e.g., the space in which a scene is displayed) according to one or more applications 640 for presentation on a display 638. As an example, the GPU 100 renders graphics objects (e.g., sets of primitives) for a scene to be displayed so as to produce pixel values representing a rendered frame 645. In at least some embodiments, the rendered frame 645 is based on raytracing operations executed at the raytracing hardware 110, and based on work items as described herein. The GPU 100 then provides the rendered frame 645 (e.g., pixel values) to display 128. These pixel values, for example, include color values (YUV color values, RGB color values), depth values (z-values), or both. After receiving the rendered frame 645, display 638 uses the pixel values of the rendered frame 645 to display the scene including the rendered graphics objects. To render the graphics objects, the GPU 100 implements processor cores (not shown) that execute instructions concurrently or in parallel. In embodiments, one or more processor cores of the GPU 100 each operate as a compute unit configured to perform one or more operations for one or more instructions received by the GPU 100. These compute units each include one or more single instruction, multiple data (SIMD) units that perform the same operation on different data sets to produce one or more results.

In embodiments, processing system 630 also includes CPU 632 that is connected to the bus 635 and therefore communicates with the GPU 100 and the memory 636 via the bus 635. CPU 102 implements a plurality of processor cores 644-1 to 644-M that execute instructions concurrently or in parallel. Though in the example implementation illustrated in FIG. 1, three processor cores (644-1, 644-2, 644-M) are presented representing an M number of cores, the number of processor cores 104 implemented in CPU 632 is a matter of design choice. As such, in other implementations, CPU 632 can include any number of processor cores 644. The processor cores 644 of CPU 632 are configured execute instructions such as program code 648 for one or more applications 640 (e.g., graphics applications, compute applications, machine-learning applications) stored in the memory 636, and CPU 632 stores information in the memory 636 such as the results of the executed instructions. CPU 632 is also able to initiate graphics processing by issuing draw calls to the GPU 100.

In some embodiments, the processing system 630 includes input/output (I/O) engine 637 that includes circuitry to handle input or output operations associated with display 638, as well as other elements of the processing system 630 such as keyboards, mice, printers, external disks, and the like. The I/O engine 637 is coupled to the bus 635 so that the I/O engine 637 communicates with the memory 636, the GPU 100, and the central processing unit (CPU) 632. In some embodiments, the CPU 632 issues one or more draw calls or other commands to the GPU 100. In response to the commands, the GPU 100 schedules, via the scheduler 102, one or more raytracing operations at the raytracing hardware 110. For at least one of the raytracing operations, the raytracing hardware 110 employs one or more work items as described above. Based on the raytracing operations, the GPU 100 generates a rendered frame, and provides the rendered frame to the display 638 via the I/O engine 637.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to identifying a first node intersection result at a first node of a raytracing structure based on first ray information associated with a first ray, storing a first work item representing first traversal state information for the first ray different from the first ray information; and
traversing a first section of the raytracing structure based on the stored first work item.

2. The method of claim 1, further comprising:
in response to identifying the first node intersection result, storing a second work item representing second traversal state information for the first ray; and
traversing a second section of the raytracing structure based on the stored second work item, the second section different from the first section.

3. The method of claim 2, wherein the first work item includes a link to the second work item.

4. The method of claim 1, further comprising:
in response to identifying a second node intersection result at a second node of a raytracing structure based on the first ray, storing a second work item representing second traversal state information for the first ray; and
traversing a second section of the raytracing structure based on the stored second work item.

5. The method of claim 1, wherein traversing the first section of the raytracing structure comprises accessing the first ray information based on the first work item.

6. The method of claim 1, wherein the first work item includes at least one of: a ray identifier that identifies the first ray, an identifier of the first node, an identifier of a current node associated with traversing the first section of the raytracing structure, an identifier of a head node of the raytracing structure, an identifier of a terminal node of the raytracing structure, and an identifier of a second work item.

7. The method of claim 1, wherein the raytracing structure comprises a bounding volume hierarchy (BVH) tree.

8. The method of claim 1, further comprising:
for a second ray, concurrently traversing a second section of the raytracing structure based on a second work item representing second traversal state information for the second ray.

9. The method of 8, further comprising:
generating the second work item based on a node intersection at a second node of the raytracing structure.

10. A processing unit, comprising:
a memory; and
a raytracing traversal engine configured to:
in response to identifying a first node intersection result at a first node of a raytracing structure based on first ray information associated with a first ray, store at the memory a first work item representing first traversal state information for the first ray different from the first ray information; and
traverse a first section of the raytracing structure based on the first work item.

11. The processing unit of claim 10, wherein the traversal engine is configured to:
in response to identifying the first node intersection result, store a second work item representing second traversal state information for the first ray; and
traverse a second section of the raytracing structure based on the stored second work item, the second section different from the first section.

12. The processing unit of claim 11, wherein the first work item includes a link to the second work item.

13. The processing unit of claim 10, wherein the traversal engine is configured to:
in response to identifying a second node intersection result at a first node of a raytracing structure based on the first ray, store a second work item representing second traversal state information for the first ray; and
traverse a second section of the raytracing structure based on the stored second work item.

14. The processing unit of claim 10, wherein traversing the first section of the raytracing structure comprises accessing the first ray information based on the first work item, the first work item comprising at least one of a ray identifier that identifies the first ray, an identifier of the first node, an identifier of a current node associated with traversing the first section of the raytracing structure, an identifier of a head node of the raytracing structure, an identifier of a terminal node of the raytracing structure, and an identifier of a second work item.

15. A processing system comprising:
a bus;
a first processing unit to provide a draw command via the bus; and
a second processing unit to receive the draw command via the bus, and comprising:
a raytracing traversal engine configured to, in response to the draw command:
in response to identifying a first node intersection result at a first node of a raytracing structure based on first ray information associated with a first ray, store at the memory a first work item representing first traversal state information for the first ray different from the first ray information; and
traverse a first section of the raytracing structure based on the first work item.

16. The processing system of claim 15, wherein the traversal engine is configured to:
in response to identifying the first node intersection result, store a second work item representing second traversal state information for the first ray; and
traverse a second section of the raytracing structure based on the stored second work item, the second section different from the first section.

17. The processing system of claim 16, wherein the first work item includes a link to the second work item.

18. The processing unit of claim 15, wherein the traversal engine is configured to:
in response to identifying a second node intersection result at a first node of a raytracing structure based on the first ray, store a second work item representing second traversal state information for the first ray; and
traverse a second section of the raytracing structure based on the stored second work item.

19. The processing unit of claim 15, wherein the traversal engine is configured to:
traverse the first section of the raytracing structure by accessing the first ray information based on the first work item.

20. The processing unit of claim 15, wherein the first work item includes at least one of:
a ray identifier that identifies the first ray, an identifier of the first node, an identifier of a current node associated with traversing the first section of the raytracing structure, an identifier of a head node of the raytracing structure, an identifier of a terminal node of the raytracing structure, and an identifier of a second work item.
